(19) United States
(12) Patent Application Publication
(10) Pub. No.: US 2007/0107668 A1
(43) Pub. Date: May 17, 2007

(54) System for monitoring an animal

(76) Inventors: Eric T. Eaton, Lake Worth, FL (US); Nona E. Gage, Sea Ranch Lakes, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/273,151

(22) Filed: Nov. 14, 2005

(51) Int. Cl. A01K 15/02

(52) U.S. Cl. 119/719

(57) ABSTRACT

The invention concerns a system (100) for monitoring an animal. The system can include a collar (110) having a transceiver (122) and a leash (112) having a transceiver (134) in which the collar transceiver and the leash transceiver may communicate with one another. When the leash and the collar move out of a communication range of one another, the collar can initiate a tracking procedure to allow the location of an animal wearing the collar to be determined. In one arrangement, the collar can further include a GPS receiver (120). When the tracking procedure is initiated, the GPS receiver can determine the location of the animal wearing the collar.

### BACKGROUND OF THE INVENTION

1. Field of the Invention

The present invention concerns wireless communications and more particularly, wireless communications for animal accessories.

2. Description of the Related Art

Many individuals across the country have pets, such as dogs. Sometimes, these animals escape, and when they do, they put themselves, other animals and humans at risk of being injured or attacked. As such, there is a need to provide pet owners with convenient and easy to use systems that alert owners when their animals escape.

### SUMMARY OF THE INVENTION

The present invention concerns a system for monitoring an animal. The system can include a collar having a transceiver and a leash having a transceiver in which the collar transceiver and the leash transceiver communicate with one another. In one arrangement, when the leash and the collar move out of a communication range of one another, the collar can initiate a tracking procedure to allow the location of the animal wearing the collar to be determined.

The collar can further include a global positioning system receiver. When the tracking procedure is initiated, the global positioning system receiver can determine the location of the animal wearing the collar. In another arrangement, the collar may also include a second transceiver, which can be a long range transceiver. As part of the tracking procedure, the long range transceiver may communicate the location of the animal wearing the collar to a communications network.

In one embodiment, as part of the tracking procedure, the collar transceiver may transmit a notification. For example, the notification may be receivable at a second collar having a transceiver, and the second collar can include a notification module that can broadcast a notice that the animal wearing the collar is lost. As another example, the communication range between the collar and the leash may be variable, and the leash transceiver and the collar transceiver can be short range transceivers. Also, as part of the tracking procedure, portions of the collar may be placed in a low power mode.

In yet another arrangement, the collar can further include a speaker and a memory. As an example, the memory can store one or more audio files that may include one or more commands, and the commands can be broadcast over the speaker as part of the tracking procedure. The collar may further include a reward holder that can store a reward. When the reward holder is opened to retrieve the reward, a back-up tracking procedure may be initiated. Additionally, the collar can include a display, and the display can display a notification as part of the tracking procedure. As an example, the notification can be a lost animal notification and can include contact information of the animal's owner.

The present invention also concerns a collar that can include a transceiver that may communicate with another transceiver of a leash and can also include a processor coupled to the transceiver. The processor can be programmed to initiate a tracking procedure when the collar and the leash move out of a communication range of one another. The tracking procedure can allow the location of an animal wearing the collar to be determined.

The present invention also concerns a lost animal tracking collar. The collar can include a long range transceiver, a global positioning system receiver, a reward holder that can store an accessible reward and a processor coupled to the transceiver, the global positioning system receiver and the reward holder. In one arrangement, the processor can be programmed to initiate a tracking procedure when the reward holder is opened. The tracking procedure can allow the location of an animal wearing the collar to be determined.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a system for monitoring an animal in accordance with an embodiment of the inventive arrangements; and

FIG. 2 illustrates an example of a block diagram of the system of FIG. 1 in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” and “engagement,” as used herein, are defined as connected, although not necessarily directly, and not necessarily mechanically. The term “module” can be defined as any combination of hardware and/or software to enable an appropriate function to be performed.

The terms “program,” “application,” and the like as used herein, are defined as a sequence of instructions designed for execution on a computer system. A program, computer program, or application may include a subroutine, a function, a procedure, an object method, an object implementation, an executable application, an applet, a servlet, a source code, an object code, a shared library/dynamic load library and/or other sequence of instructions designed for execution on a computer system. Where suitable, the term “application” may even refer to a hardware setting or component.

The present invention concerns a system for monitoring an animal. The system can include a collar having a transceiver and a leash having a transceiver in which the collar transceiver and the leash transceiver communicate with one another. When the leash and the collar move out of a communication range of one another, the collar can initiate a tracking procedure to allow the location of the animal wearing the collar to be determined.

In one arrangement, the collar can further include a global positioning system (GPS) receiver. When the tracking procedure is initiated, the GPS receiver may determine the location of the animal wearing the collar. The collar can further include a second transceiver. The second transceiver may be a long range transceiver, and as part of the tracking procedure, the long range transceiver can communicate the location of the animal wearing the collar to a communications network. The system can thus provide an easy, convenient and safe way for owners to be informed when their animal(s) may escape.

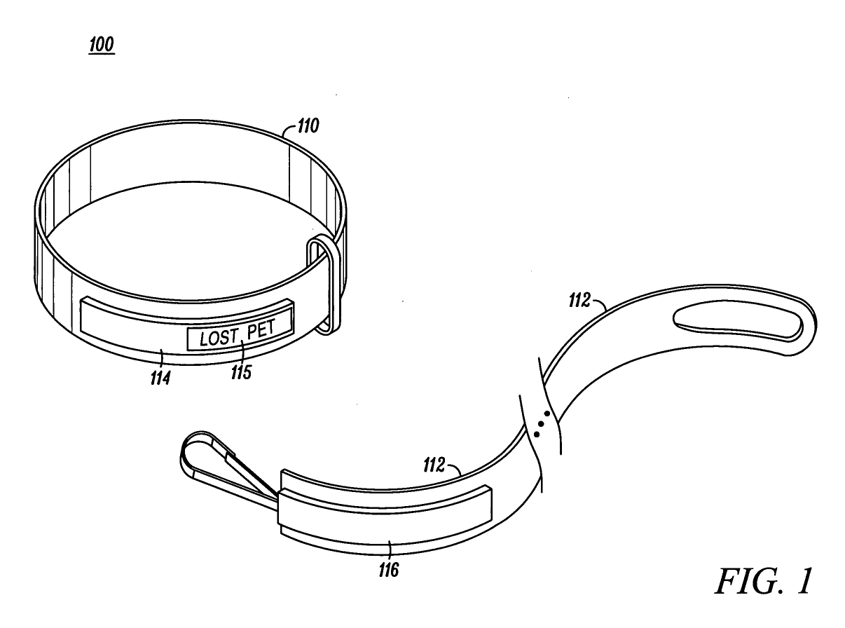

Referring to FIG. 1, an example of a system 100 for monitoring an animal is shown. In one arrangement, the system 100 can include a collar 110 and a leash 112, which can engage the collar 110. The collar 110 can be attached to the animal in any suitable manner to allow a user to have at least some control over the animal. The collar 110 can include a casing 114 that can store several components, as will be described below. One of these components can be a display 115, which can display various types of information. Some examples of this information will be presented later. The leash 112 may also include a casing 116 that can house several elements, which will also be explained below. In one arrangement, the collar 110 and the leash 112 may have transceivers (not shown here) that can communicate with one another.

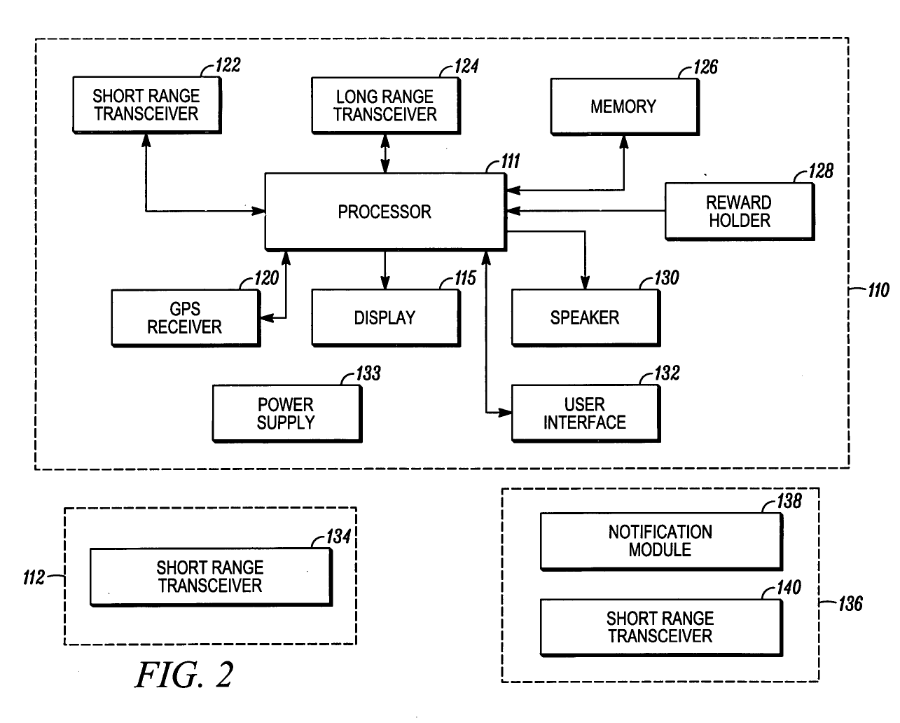

Referring to FIG. 2, block diagrams of examples of the collar 110, the leash 112 and a second collar 118 are shown. In one arrangement, the collar 110 can include a processor 111, the display 115, a GPS receiver 120, a short range transceiver 122, a long range transceiver 124, a memory 126, a reward holder 128, a speaker 130, a user interface 132 and a power supply 133. The power supply 133 can be, for example, a rechargeable or disposable battery and can provide power to any one of the components listed here. The processor 111 can be coupled to and can control the operation of any one of the above-recited components. The processor 111 can include any suitable number of processors and/or controllers to carry out the functions and processes that will be described herein.

The GPS receiver 120, as is known in the art, can obtain positional information of the collar 110 from a plurality of GPS satellites (not shown). Those of skill in the art, however, will appreciate that there are several other ways to acquire the location of the collar 110. In one arrangement, the short range transceiver 122 can communicate with another short range transceiver 134 of the leash 112. As an example, the short range transceivers 122, 134 can communicate with one another using any suitable short range communications protocol, such as Bluetooth or any one of the standards of the 802.11 family. In particular, the term short range transceiver can refer to any transceiver that is intended to transmit and/or receive signals between itself and another component without relying on a repeater to relay the signals. In addition, the term transceiver can refer to any component that is capable of either transmitting or receiving radio frequency (RF) signals. Moreover, the collar 110 can have any suitable number of short range transceivers 122.

The short range transceivers 122, 134 can have a communication range. Within the communication range, the signal strength from the transceivers 122, 134 can be at or above a predetermined value. Outside the communication range, the signal strength can be below this predetermined value. By monitoring such signal strengths, it can be determined when the collar 110 and the leash 112 have moved outside the communication range. The communication range can represent any suitable distance and can depend on the type of transceivers 122, 134 used. In one arrangement, the communication range can be variable. For example, a user may adjust the transmission power of one or both of the transceivers 122, 134. Several processes can be performed after the collar 110 and leash 112 move beyond their communication range, as will be described later.

In one arrangement, the long range transceiver 124 can communicate with one or more communications networks (not shown). That is, a long range transceiver can be considered any transceiver that is intended to rely on a repeater to relay communications signals to another communications unit. As an example, the long range transceiver 124 can employ any suitable type of long range communications protocol or standard, such as GSM, CDMA, iDEN, UMTS, etc. In short, the long range transceiver 124 can transmit information to and receive information from any suitable communication network. The collar 110 can include any suitable number of long range transceivers 124, too.

The memory 126 can be any suitable type of data storage unit, and it may be a discrete component or it can be part of the processor 111. In one particular example, the memory 126 can store audio files, and these audio files may be broadcast over the speaker 130. The memory 126 may also store contact information of the owner of an animal wearing the collar 110, such as the owner's name, home or work address, phone numbers and e-mail addresses. In one arrangement, this contact information can be displayed on the display 115. Also, as an example, the user interface 132 can be a keypad having a plurality of keys and a microphone, and a user can enter his or her contact information into the memory 126 through the user interface 132. A user may also program the collar 110 through the user interface 132 with which particular steps to take during a tracking procedure, and this predetermined routine may be stored in the memory 126.

The reward holder 128 can be a physical storage component that can store any suitable type of reward, such as cash. The reward holder 128 may include a door (not shown) that can be opened to permit a person to retrieve the reward. When this door is opened, the reward holder 128 can signal the processor 111, which can trigger certain procedures, as will be explained later.

The system 100 may also include a second collar 136 that may be worn by an animal, and the second collar 136 can also have a short range transceiver 140 that can communicate with the short range transceiver 122 of the collar 110. In addition, the second collar 136 can include a notification module 138, such as a speaker and/or a display. The notification module 138 can display or broadcast information that is received at the transceiver 140 from the transceiver 122 of the collar 110.

In operation, the short range transceiver 122 of the collar 110 may be communicating with the short range transceiver 134 of the leash 112. Passive or active scanning can be performed by either one of the transceivers 122, 134 to carry out this communication. As noted above, the transceivers 122, 134 can have a communication range. During this communication, the processor 111 can monitor the signal strength of the signals received from the transceiver 134 of the leash 112 to determine if the transceivers 122, 134 have moved outside the communication range. If the signal strength drops below a predetermined value or threshold, then the processor 111 can determine that the collar 110 has moved outside this communication range and can initiate a tracking procedure. Such a situation may occur if the animal wearing the collar 110 has escaped from a yard or home or some other enclosure or boundary.

As an example of a tracking procedure, the processor 111 can signal the GPS receiver 120 to obtain the location of the collar 110. Once obtained, the processor 111 can instruct the long range transceiver 124 to signal the appropriate communications network with the location of the collar 110. In accordance with the instructions pre-programmed by the owner or user, the communications network can then signal the appropriate contact number or address.

For example, the network may place a call to a number of the owner's choice and the network can play a recording that notifies the owner or other person that the animal wearing the collar 110 may have escaped and can recite the location of the collar 110. Alternatively, the communication network may send an e-mail with such information. Those of skill in the art will appreciate that there are numerous ways to forward to a relevant party the escaped or lost animal notice and the location of the collar 110. This process can be repeated any suitable number of times to permit the relevant party to be updated with the animal's location.

In another arrangement, a lost animal or pet notice can be displayed on the display 115 and/or a similar message can be broadcast over the speaker 130. Either of these notices or messages may also include appropriate contact information of the animal's owner.

In yet another example of a tracking procedure, the processor 111 can instruct the short range transceiver 122 to begin transmitting on a periodic basis. Specifically, the transceiver 122 can transmit a lost animal notification along with contact information of the animal's owner. This transmitted information may be received by the short range transceiver 140 of a second collar 136. Once received at the second collar 136, this information can be displayed or broadcast at the notification module 138. The owner or person in control over the animal wearing the second collar 136 can then be notified that the animal wearing the collar 110 has escaped. This person has the option of then contacting the owner of the lost animal.

As described above, the memory 126 of the collar 110 can store one or more audio files, which can be played over the speaker 130. These audio files may be commands from the owner or some other person. For example, the owner, through the user interface 132, may record one or more commands that may be recognized by the animal wearing the collar 110, such as “sit” or “stay” or “come home,” depending on the animal's prior training. As part of the tracking procedure, the processor 111 can retrieve these commands from the memory 126 and can cause them to be broadcast over the speaker 130. As a result, the escaped animal may hear, recognize and possibly submit to these pre-recorded commands.

As another part of the tracking procedure, portions of the collar 110 may be placed in a low power mode. For example, the processor 111 may disable certain functions or enter into deep sleep stages. Also, if one of the long range transceiver 124 or the short range transceiver 122 is able to establish communications with a network or another short range transceiver, respectively, then the transceiver 122,124 that has yet to make contact may be disabled in an effort to conserve power for the transceiver 122, 124 that has. Further, the frequency at which the GPS receiver 120 obtains positional information can be reduced as the energy of the power supply 133 decreases. Those of skill in the art will appreciate that other non-essential components of the collar 110 may be disabled, and any suitable priority ranking system can be employed here.

As a back-up tracking procedure, a person may open the door to the reward holder 128. For example the person may recognize that the animal wearing the collar 110 has escaped and is lost. When this person opens the door of the reward holder 128, the person can retrieve the reward stored inside. In addition, the reward holder 128 can signal the processor 111. When signaled, the processor 111 can initiate the tracking procedure, in accordance with any of the steps described above.

This tracking procedure may be considered a back-up procedure. In particular, there may be a malfunction in determining that the collar 110 has moved outside the communication range, and the reward holder 128 can be the device that starts the tracking procedure. As another alternative, the reward holder 128 can be used as the primary means to initiate the procedure. For example, the collar 110 may not include a short range transceiver 122, and accessing the reward in the reward holder 128 can actually trigger the tracking procedure.

It should be noted that the invention is not limited to the above examples of steps that may be performed during a tracking procedure. Those of skill in the art will appreciate that other suitable actions for determining the location of the animal and assisting in its safe return to its owner are within contemplation of the inventive arrangements. Also, when considering the examples recited above, it is important to note that the invention is not required to include all of them as part of a tracking procedure. In fact, any suitable combination of these examples and other processes not described here can form a tracking procedure.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A system for monitoring an animal, comprising:
a collar having a transceiver; and
a leash having a transceiver, wherein the collar transceiver and the leash transceiver communicate with one another;
wherein when the leash and the collar move out of a communication range of one another, the collar initiates a tracking procedure to allow the location of the animal wearing the collar to be determined.

2. The system according to claim 1, wherein the collar further includes a global positioning system receiver, wherein when the tracking procedure is initiated, the global positioning system receiver determines the location of the animal wearing the collar.

3. The system according to claim 2, wherein the collar further includes a second transceiver, wherein the second transceiver is a long range transceiver and as part of the tracking procedure, the long range transceiver communicates the location of the animal wearing the collar to a communications network.

4. The system according to claim 1, wherein as part of the tracking procedure, the collar transceiver transmits a notification.

5. The system according to claim 4, wherein the notification is receivable at a second collar having a transceiver, wherein the second collar includes a notification module that broadcasts a notice that the animal wearing the collar is lost.

6. The system according to claim 1, wherein the communication range between the collar and the leash is variable.

7. The system according to claim 1, wherein the leash transceiver and the collar transceiver are short range transceivers.

8. The system according to claim 1, wherein as part of the tracking procedure, portions of the collar are placed in a low power mode.

9. The system according to claim 1, wherein the collar further includes a speaker and a memory, wherein the memory stores one or more audio files that include commands and wherein the commands are broadcast over the speaker as part of the tracking procedure.

10. The system according to claim 1, wherein the collar further includes a reward holder that stores a reward, wherein when the reward holder is opened to retrieve the reward, a back-up tracking procedure is initiated.

11. The system according to claim 1, wherein the collar includes a display and the display displays a notification as part of the tracking procedure.

12. The system according to claim 11, wherein the notification is a lost animal notification and includes contact information of the animal's owner.

13. A collar, comprising:
a transceiver that communicates with another transceiver of a leash; and
a processor coupled to the transceiver, wherein the processor is programmed to initiate a tracking procedure when the collar and the leash move out of a communication range of one another, wherein the tracking procedure allows the location of an animal wearing the collar to be determined.

14. The collar according to claim 13, further comprising a global positioning system receiver, wherein when the tracking procedure is initiated, the global positioning system receiver determines the location of the animal wearing the collar.

15. The collar according to claim 14, further comprising a second transceiver, wherein the second transceiver is a long range transceiver and as part of the tracking procedure, the long range transceiver communicates the location of the animal wearing the collar to a communications network.

16. The collar according to claim 13, wherein as part of the tracking procedure, the collar transceiver transmits a notification that is receivable at a second collar having a transceiver, wherein the second collar includes a notification module that broadcasts a notice that the animal wearing the collar is lost.

17. The collar according to claim 13, further comprising a speaker and a memory, wherein the memory stores one or more audio files that include commands and wherein the commands are broadcast over the speaker as part of the tracking procedure.

18. The collar according to claim 13, further comprising a reward holder that stores a reward, wherein when the reward holder is opened to retrieve the reward, the processor is further programmed to initiate a back-up tracking procedure.

19. The collar according to claim 13, further comprising a display and the display displays a notification as part of the tracking procedure, wherein the notification is a lost animal notification and includes contact information of the animal's owner.

20. A lost animal tracking collar, comprising:
a long range transceiver;
a global positioning system receiver;
a reward holder that stores an accessible reward; and
a processor coupled to the transceiver, the global positioning system receiver and the reward holder, wherein the processor is programmed to initiate a tracking procedure when the reward holder is opened, wherein the tracking procedure allows the location of an animal wearing the collar to be determined.
